(19) United States
(12) Patent Application Publication
(10) Pub. No.: US 2008/0096524 A1
(43) Pub. Date: Apr. 24, 2008

(54) Method for providing a multi-member mobile telecommunications service plan

(75) Inventors: Sandra Lynn True, St. Charles, IL (US); David S. Benco, Winfield, IL (US); Sanjeev Mahajan, Naperville, IL (US); Baoling S. Sheen, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/584,708

(22) Filed: Oct. 20, 2006

(51) Int. Cl. H04M 11/00

(52) U.S. Cl. 455/406

(57) ABSTRACT

A method of providing a mobile telecommunications Service Plan to a multi-member user group is provided. The Service Plan provides a predefined total resource allotment which is shared by the group once each billing cycle. The Service Plan enables a member to define separate resource allowances for each group member. Resource usage warning thresholds are defined which alert a member when the member approaches using all of his or her resources. The Service Plan enables a member to receive a resource allotment transferred from a second member upon obtaining permission from the second member. The Service Plan can also enable a member to purchase additional service resources apart from the allowances if so desired.

### BACKGROUND OF THE INVENTION

This invention relates to a method for providing mobile, also referred to as wireless, telecommunications services to a group of users, and more particularly a method of providing a multi-member mobile telecommunications Service Plan.

By way of background, many mobile telecommunications Service Providers are offering a Family Plan type of service option in which a plurality of mobile subscribers share the assets, also referred to as resources, associated with a mobile service plan agreement. For example, four members of the same family may share a combination of 1000 anytime minutes, coupled with 100 incoming and/or outgoing text messages, for a predetermined price per month.

However, these plans can create confusion among the different family members regarding how the resources are to be shared. These plans can encourage some members to operate under the assumption that they each can use the entire allotment of resources. This causes family stress when it comes time to pay the overages at the end of a billing cycle when the total resource allotment is exceeded.

The present invention contemplates a new and improved method that resolves the above-referenced difficulties and others.

### SUMMARY OF THE INVENTION

A method for providing a multi-member mobile telecommunications Service Plan is provided.

In one aspect of the invention, the method includes providing mobile telecommunications service to a multi-member user group including providing a multi-member mobile telecommunications Service Plan to the user group having a plurality of members, the Service Plan providing a predefined total resource allotment for the group per billing cycle, defining separate resource allowances per billing cycle for each group member such that the sum of all the resource allowances equals the total resource allotment per billing cycle, and enabling a first member to receive a resource allotment transfer from a second member upon obtaining permission from the second member thereby increasing the amount of the first member's resource and decreasing the amount of the second member's resource accordingly for the current billing cycle.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a mobile telecommunications network;

FIG. 2 is a flow chart illustrating steps of the invention;

FIG. 3 is a flow chart illustrating more steps of the invention;

FIG. 4 is a flow chart illustrating more steps of the invention;

FIG. 5 is a flow chart illustrating more steps of the invention; and

FIG. 6 is a flow chart illustrating more steps of the invention.

### DETAILED DESCRIPTION

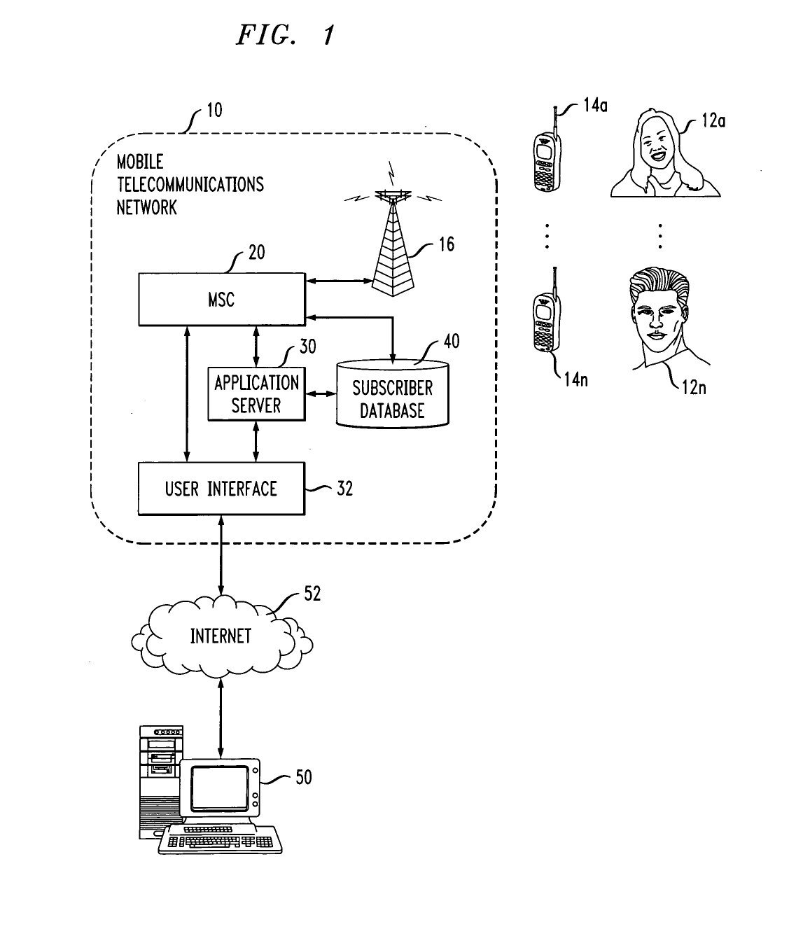

Referring now to the drawings wherein the showings are for purposes of illustrating the preferred embodiments of the invention only and not for purposes of limiting same. In FIG. 1, a mobile telecommunications network, also known as a cellular telecommunications network or wireless telecommunications network, is shown generally at 10 for providing mobile telecommunications services to a plurality of users 12a-12n via mobile terminals, also known as mobile phones or cellular phones 14a-14n. The users 12a-12n are members of a multi-member user group receiving mobile telecommunications services as provided by a mobile telecommunications Service Provider as discussed in further detail below.

The mobile telecommunications network 10 includes one or more mobile switching centers (MSC) 20 for routing calls to and from the mobile terminals 14a-14n via one or more base stations 16, only one of which is shown for simplicity. The MSC 20 also routes text messages to and from the mobile terminals 14a-14n and provides the users with other mobile telecommunications services as is known in the art.

An Application Server 30, such as a computer or server or the like, runs programmed logic to provide a method of providing a multi-member Service Plan as described in further detail below. A User Interface 32 is provided to enable subscribers to access functions or features provided by the Service Provider as related to the Service Plan in a manner described in further detail below.

A subscriber database 40 is connected to the Application Server 30 and MSC 20 for storing subscription information for the group.

A computer 50 can be connected to the User Interface 32 via the Internet 52 for accessing the functions or features provided by the Service Provider as related to the Service Plan in a manner described in further detail below

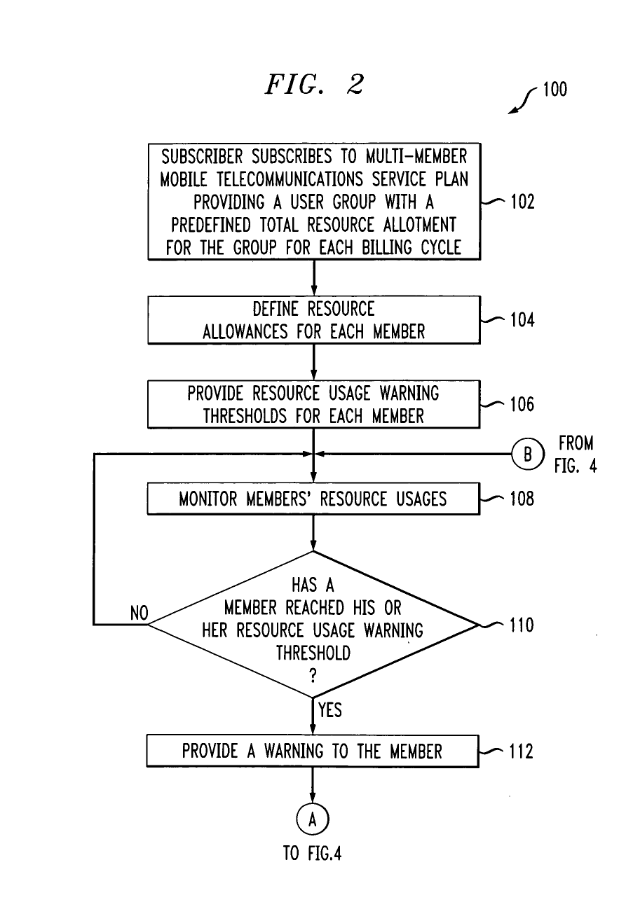

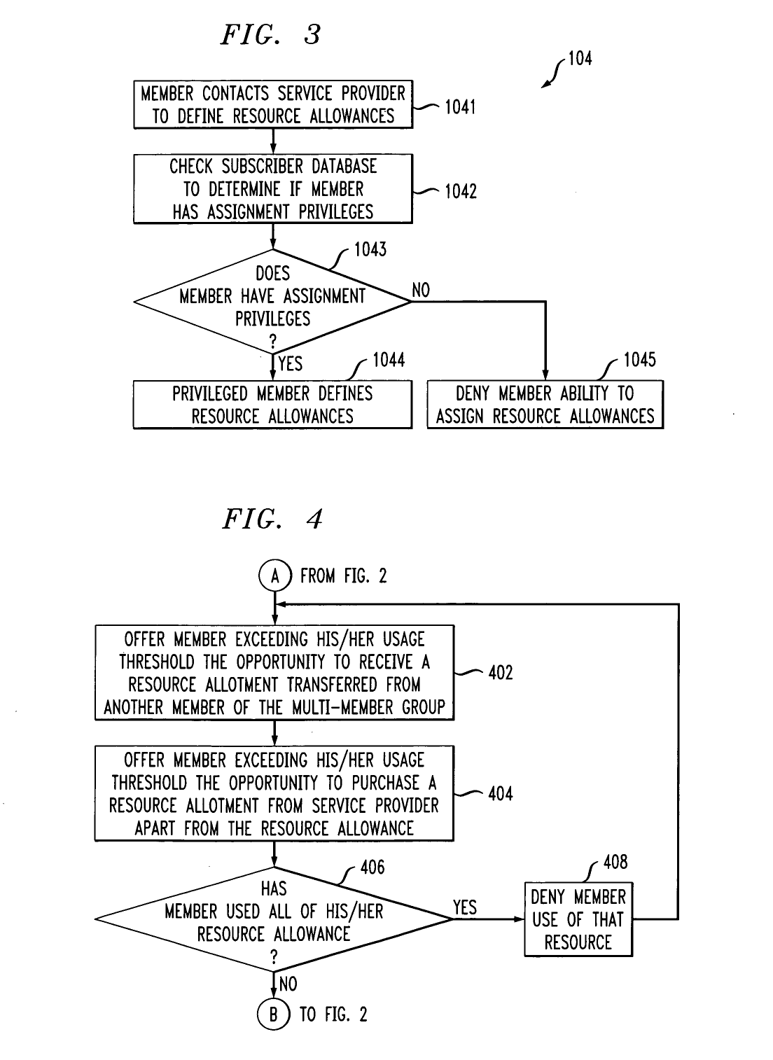

Referring now to FIGS. 2 and 3 a method for providing a multi-member telecommunications Service Plan is shown generally at 100. The Service Plan provides telecommunications services, also referred herein as telecommunications service resources, or resources, to the group members 12a-12n. In the example provided herein, the user group 12a-12n is a family having a plurality of family members, though it should be appreciated that other groups of users may subscribe to the multi-member Service Plan.

A member 12a subscribes to the multi-member Service Plan at 102. One or more members 12a-12n are designated as privileged members having privileges as defined below. This information is stored in the subscriber database 40. A privileged subscriber 12a, such as for example a mother, is responsible for paying for the multi-member Service Plan subscription once each billing cycle, such as for example once a month, and is billed for such accordingly. While a monthly billing cycle is used in the example provided herein, it should be appreciated that other periods of time may be used for the billing cycle.

The Service Plan provides a pre-defined allotment of resources, referred to as the total resource allotment, to the group 12a-12n once each billing cycle. The total resource allotment can include a number of minutes of call time, for example 1000 minutes, during which calls can be made and/or received over the mobile telecommunications network 10.

The total resource allotment can include several resource categories each applicable to a different service resource, another category being for example sending and/or receiving a predefined number of text messages, such as for example 100 text messages.

The total resource allotment is shared by the group members 12a-12n via resource allowances. A resource allowance is given to each group member once each billing cycle. The resource allowances are defined for each group member at 104 such that the sum of all the resource allowances for the billing cycle equals the total resource allotment for the billing cycle. The resource allowances can be the same for each group member, such as 4 group members each having 250 minutes of call time for each billing cycle. Alternatively, different resource allowances can be given to different group members. Further, some group members may not receive a resource allowance for every category. For example, in a group including a father, mother and two children, the 100 text messages may be split only between the children, if so desired.

Referring now to FIG. 3, the privileged member 12a can define the resource allowances as shown in step 104. More specifically, the privileged member 12a contacts the Service Provider at 1041 in an attempt to define the resource allowances. The privileged member 12a can use a computer 50 connected to a User Interface 32 provided by the Service Provider Application Server 30 via the Internet 52. Alternatively, the privileged member 12a can use her mobile terminal 14a to connect to the Application Server 30 via the User Interface 32. Alternatively, the privileged member can speak to a Service Provider Operator functioning as the User Interface 32 via a phone, such as the mobile terminal 14a.

The Application Server 30 checks with the subscriber database 40 at 1042 to determine if the privileged member has authorization to define the resource allowances, that is to say if the member is a privileged member. If it is determined that the member is a privileged member at 1043 the privileged member is allowed to define the resource allowances for each member at 1044. The resource allowances can be stored in the subscriber database 40, or other node in the network 10, and communicated to the Application Server 30 as needed or stored at the Application Server itself. If it is determined that the member is not a privileged member at 1043, the member cannot define the resource allowances as shown at 1045.

Referring again to FIG. 2, the method 100 also includes providing resource usage warning thresholds for each member 12a-12n at 108. The thresholds are used for warning a member that he or she has almost used up all of his or her resource allowance for the billing cycle as shall be described in further detail below.

The resource usage warning threshold equals a percentage of less than 100 percent of a member's resource allowance. In the example provided herein, a threshold of 90 percent of the member's resource allowance is used, however it should be appreciated that other threshold percentages can be used. The resource usage warning threshold can be set by the Service Provider. Alternatively, each member can set his or her own usage warning threshold to any percentage, up to 100 percent, of the member's resource allowance using the User Interface 32 described above.

Further, a resource usage warning threshold can be set for each resource allowance category a member receives. For example, a warning threshold can be set for a son's call time minutes and for his text messages sent/received.

The method 100 also includes monitoring each member's resource usages at 108. This can be done by the Application Server 30 or by another node in the network 10, such as the members' MSC 20 and communicated to the Application Server.

The method 100 also includes determining that a member has reached his or her warning threshold for a particular resource at 110 and providing a warning to the member at 112. The warning can be a message sent to the member, such as a text message or a voice mail message, among others, stating that the member is approaching using all of his or her resource allowance for the billing cycle. For example, when the son or daughter uses 225 call time minutes of his or her 250 call time minutes allowance, in the example provided above with a 90% threshold, his or her warning threshold for call time minutes is met and a warning message is sent informing him or her accordingly. The warning can provide the person receiving it with the amount of the resource he or she has left if so desired.

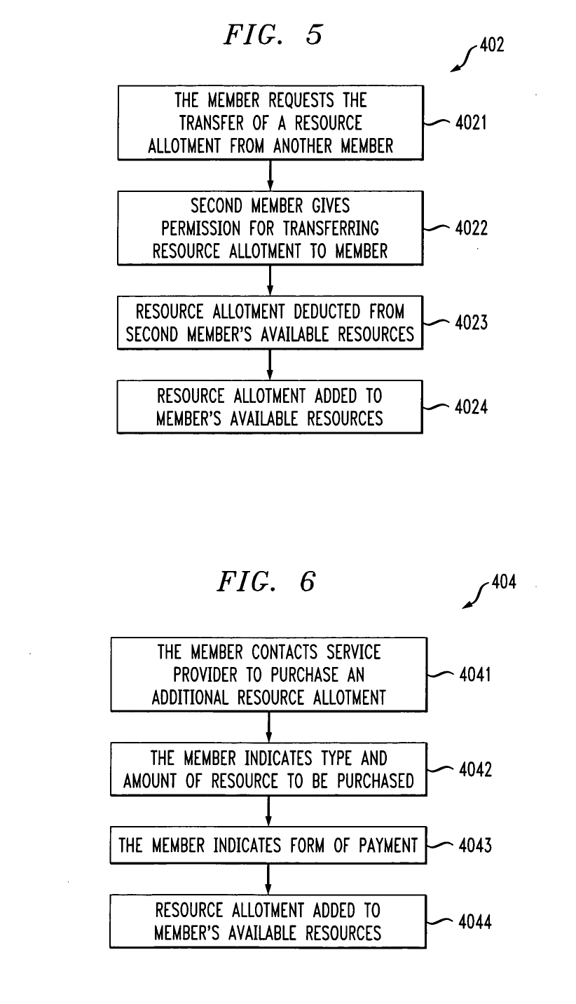

Referring now to FIGS. 4 and 5, the method 100 also includes offering the member exceeding his or her resource usage threshold as determined in step 110 above the opportunity to receive a resource allotment transferred from another member of the multi-member group at 402. This offer can be provided to the member in the warning message sent in 112 or via another message if so desired.

One example in which this can be accomplished, which should not be considered limiting, is shown in further detail in FIG. 5. Upon receiving the offer in 402, the member requests the transfer of a resource allotment for the corresponding resource from another member having unused resources. The member can contact Service Provider via the User Interface 32 and be provided with the amount unused resources the other members have available. The member can request the transfer of the resource allotment from another member having sufficient unused resources via a text message or other message. This request can be generated via the User Interface 32 and initiated by the member in an automated manner. The member receiving the request can then give permission for transferring a resource allotment to the member at 4022. This can be automated using the User Interface 32, for example the second member can simply acknowledge acceptance via the User Interface 32 which is transferred to the Application Server 30. The resource allotment is deducted from the second member's available resources at 4023 and added to the first member's available resources, the remainder of his resource allowance, at 4024.

Referring again to FIG. 4, the method 100 can further include offering at a member exceeding his or her usage threshold the opportunity to purchase a resource allotment from the Service Provider apart from his or her resource allowance 404. This transaction can be confidential, that is, not made known to the other members of the group if so desired.

One example in which this can be accomplished, which should not be considered limiting, is shown in further detail in FIG. 6. Upon receiving the offer in 404, the member contacts the Service Provider to purchase an additional resource allotment at 4041. The member can use the User Interface 32 described above.

The member indicates at 4042 the type and the amount of the resource he or she wants to purchase, such as for example 60 call time minutes. The member also indicates how he or she would like to pay for the resource allotment at 4043. The payment can be deducted from a prepaid account balance setup by the privileged member or paid for directly by the member such as via a credit card or the like. The resource allotment is then added to the member's available resources at 4044 for use.

The method 100 can also include determining if a member has used all of his or her resource allotment for any particular resource category at 406. The member's resource allotment can include the member's resource allowance plus any allotment of that resource obtained from another member, or from the Service Provider, as described above. If a member has used all of his or her resource allotment, the method can include denying that member the further use of that resource for the rest of the billing cycle at 408. The member can be allowed to make Emergency 911 calls regardless of call time minutes available if so desired.

When it is determined that a member has used all of his or her resource allotment at 406, the member can be offered the opportunity to receive a resource allotment from another member as described at 402 above or the opportunity to purchase a resource allotment from the service provider as described at 404 above if so desired.

The method 100 can include continuing to monitor the members' resource usages as described at 108 and following the applicable steps subsequent thereto as described above.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of providing mobile telecommunications service to a multi-member user group comprising:
providing a multi-member mobile telecommunications Service Plan to the user group having a plurality of members, the Service Plan providing a predefined total resource allotment for the group per billing cycle;
defining separate resource allowances per billing cycle for each group member such that the sum of all the resource allowances equals the total resource allotment per billing cycle; and
enabling a first member to receive a resource allotment transfer from a second member upon obtaining permission from the second member thereby increasing the amount of the first member's resource and decreasing the amount of the second member's resource accordingly for the current billing cycle.

2. The method defined in claim 1 wherein the defining step includes a privileged member of the group defining the separate resource allowances.

3. The method defined in claim 1 further comprising enabling the first member having exceeded the first member's resource allowance to purchase an additional resource allotment from the Service Provider thereby increasing the amount of the first member's resource allowance accordingly for the current billing cycle.

4. The method defined in claim 3 further comprising:
the Service Provider billing at least one member of the multi-member group for the multi-member service plan each billing cycle; and
the Service Provider billing the first member directly, apart from the billing for the multi-member service plan, for the purchase of the additional resource allotment.

5. The method defined in claim 3 further comprising:
establishing a pre-paid account balance; and
decrementing the pre-paid account balance by an amount used for purchasing the additional resource allotment.

6. The method defined in claim 1 further comprising providing the current resource usage amounts for every member for the current billing cycle to any member.

7. The method defined in claim 1 further comprising denying the first member the use of a resource without denying the first member the ability to make E911 calls when the first member has exceeded the first member's resource allotment for that resource.

8. The method defined in claim 1 further comprising:
providing a resource usage warning threshold for each member equaling a percentage of less than 100% of the member's resource allowance; and
providing a warning to the first member when the first member's resource usage meets or exceeds the resource usage warning threshold for that resource, the warning indicating that the first member is approaching the use of all of the first member's resource allowance for the current billing cycle.

9. The method defined in claim 8 wherein the enabling step further comprises enabling the first member to accept the resource allotment from the second member when the first member exceeds the first member's resource usage warning threshold.

10. The method defined in claim 8 wherein the step of providing a resource usage warning threshold includes enabling each member to set his or her own resource usage warning threshold.

11. The method defined in claim 10 wherein the step of providing a resource usage warning threshold includes enabling each member to set his or her own resource usage warning threshold for each separate resource category.

12. The method defined in claim 1 wherein the enabling step further comprises enabling the first member to accept a resource allotment from the second member when the first member meets or exceeds the first member's resource allowance.

13. The method defined in claim 1 further comprising enabling any number of members of the user group to receive a resource allotment transfer from any other member of the user group upon obtaining permission from the any other member.

14. A method of providing mobile telecommunications service to a multi-member user group comprising:
providing a multi-member service plan to the user group having a plurality of members, the plan providing a predefined total resource allotment for the group per billing cycle;
assigning separate resource allowances per billing cycle for each group member such that the sum of all the resource allowances equals the total resource allotment per billing cycle;
providing a resource usage warning threshold for each member equaling a percentage of less than 100% of the member's resource allowance;
providing a warning to a first member when the first member's resource usage has met the resource usage warning threshold, the warning indicating that the first member has limited amount of resources available for the current billing cycle;
accepting permission from a second member for a resource allotment transfer; and
transferring a resource allotment from the second member to the first member upon obtaining permission from the second member thereby increasing the first member's resource allowance and decreasing the second member's resource allowance accordingly for the current billing cycle.
